(19) United States
(12) Patent Application Publication
(10) Pub. No.: US 2025/0167310 A1
(43) Pub. Date: May 22, 2025

(54) Low-Emission Cylindrical-Winding Battery Design

(71) Applicant: Google LLC, Mountain View, CA (US)

(72) Inventors: Jianmin Zhang, Los Gatos, CA (US); Mingfeng Xue, Mountain View, CA (US); Chi Kin Benjamin Leung, Sunnyvale, CA (US); Ramesh C. Bhardwaj, Fremont, CA (US); Sheba Devan, Pleasanton, CA (US)

(73) Assignee: Google LLC, Mountain View, CA (US)

(21) Appl. No.: 19/033,274

(22) Filed: Jan. 21, 2025

Related U.S. Application Data
(63) Continuation-in-part of application No. 18/593,008, filed on Mar. 1, 2024.
(60) Provisional application No. 63/557,323, filed on Feb. 23, 2024.

(51) Int. Cl. H01M 10/0587; H01M 10/0525; H01M 50/497; H01M 50/531

(52) U.S. Cl. CPC H01M 10/0587; H01M 10/0525; H01M 50/497; H01M 50/531

(57) ABSTRACT

The present document describes a low-emission cylindrical-winding battery design. The battery design is a rolled and stacked battery, with two or more winding rolls of cathode and anode layers separated by insulation layers, the winding rolls also being separated by a distance with the distance, in some embodiments, filled with a dielectric material. A first winding roll of first stacked anode and cathode layers and a second winding roll of second stacked anode and cathode layers are wound in a direction around a central axis of the battery. The first winding roll of first stacked anode and cathode layers follows a first stacking order with the anode and cathode layers alternating. The second winding roll of second stacked anode and cathode layers follows a second stacking order with the anode and cathode layers alternating opposite to the first stacking order. The alternating stacking orders cause the battery to produce a reduced H-field when compared with a battery having non-alternating stacking orders.

### RELATED APPLICATION(S)

This application is a continuation-in-part of and claims priority to U.S. Non-Provisional patent application Ser. No. 18/593,008, filed Mar. 1, 2024, which in turn claims the benefit of U.S. Provisional Patent Application No. 63/557,323, filed Feb. 23, 2024, the disclosures of which are incorporated by reference herein in their entireties.

### BRIEF SUMMARY

The present document describes a low-emission cylindrical-winding battery design. The battery design is a rolled and stacked battery, with two or more winding rolls of cathode and anode layers separated by insulation layers, the winding rolls also being separated by a distance, the distance in some embodiments filled with an insulating layer (e.g., a dielectric material). In aspects, a first winding roll of first stacked anode and cathode layers and a second winding roll of second stacked anode and cathode layers are wound in a direction around a central axis of the battery. The first winding roll of first stacked anode and cathode layers follows a first stacking order with the anode and cathode layers alternating. The second winding roll of second stacked anode and cathode layers follows a second stacking order with the anode and cathode layers alternating opposite to the first stacking order. Subsequent winding rolls may, in some examples, follow this alternating pattern of anode and cathode layer order. By alternating the stacking orders, a surface current of the battery is greatly reduced, corresponding to a greatly reduced H-field propagation outside of the confines of the winding rolls of the battery. This substantially mitigates unwanted effects of the H-field, such as electronic noise (eNoise) in a speaker of an electronic device when the electronic device includes both the battery and a speaker or other components, which may be negatively affected by H-fields.

In an example, a battery is disclosed. The battery has a symmetry about an axis and includes a first plurality of layers, the first plurality of layers including first alternating cathode and anode layers, the first alternating cathode and anode layers electrically isolated from one another and disposed such that the first plurality of layers define a first cylindrical-winding roll about the axis. The battery also includes a second plurality of layers, the second plurality of layers including second alternating cathode and anode layers, the second alternating cathode and anode layers electrically isolated from one another and disposed such that the second plurality of layers define a second cylindrical-winding roll about the axis. The second cylindrical-winding roll is adjacent to and electrically isolated from the first cylindrical-winding roll, and the second alternating cathode and anode layers are arranged about the axis in an opposite order as the first alternating anode and cathode layers.

In aspects, the battery may further include an outer negative terminal for providing a current to both the first plurality of layers and the second plurality of layers. The outer negative terminal is in electrical connection to the first anode layers and the second anode layers at their farthest point from the axis. In some examples, the battery further includes an outer positive terminal for collecting the current within the first plurality of layers and the second plurality of layers. The outer positive terminal is in electrical connection to the first cathode layers and the second cathode layers at their farthest point from the axis.

In aspects, the battery may further include an inner negative terminal for providing a current to both the first plurality of layers and the second plurality of layers. The inner negative terminal is in electrical connection to the first anode layers and the second anode layers at their closest point from the axis. In some examples, the battery further includes an inner positive terminal for collecting the current within the first plurality of layers and the second plurality of layers. The inner positive terminal is in electrical connection to the first cathode layers and the second cathode layers at their closest point from the axis. In some examples, the electric isolation of the first plurality of layers from the second plurality of layers is achieved using a dielectric isolation layer therebetween. In aspects, the symmetry is a radial symmetry about the axis, the axis being a central axis.

According to some examples, the battery further includes a third plurality of layers, the third plurality of layers including third alternating cathode and anode layers, which are electrically isolated from one another and disposed such that the third plurality of layers define a third cylindrical-winding roll about the axis. The third cylindrical-winding roll is adjacent to and electrically isolated from the second cylindrical-winding roll and the third alternating cathode and anode layers are arranged about the axis in a same order as the first alternating anode and cathode layers. According to some examples, the electric isolation of the third plurality of layers from the second plurality of layers is achieved using a dielectric isolation layer therebetween. In aspects, the first cylindrical-winding roll and the second cylindrical-winding roll are separated by a distance.

This summary is provided to introduce simplified concepts of a low-emission cylindrical-winding battery design, which are further described below in the Detailed Description. This summary is not intended to identify essential features of the claimed subject matter.

### BRIEF DESCRIPTION OF THE DRAWINGS

The details of one or more aspects of a low-emission cylindrical-winding battery design are described in this document with reference to the following drawings. The same numbers are used throughout the drawings to reference like features and components:

FIG. 1 illustrates an example implementation of a standard cylindrical-winding battery configuration;

FIG. 2 illustrates an example implementation of a low-emission cylindrical-winding battery configuration;

FIG. 3 illustrates a side plan view of the example battery from FIG. 2;

FIG. 4 illustrates an interior portion view of the example battery from FIG. 2;

FIG. 5 illustrates a comparative H-field propagation between a standard cylindrical-winding battery configuration and a low-emission cylindrical-winding battery configuration.

### DETAILED DESCRIPTION

The present document describes a low-emission cylindrical-winding battery design. Electric current running through a battery generates a magnetic field (H-field), which can induce nearfield coupling (e.g., electromagnetic coupling) with a nearby electronic circuit and cause unwanted electromagnetic interference. In some examples, this nearfield coupling is presented in the form of eNoise, which can produce an audible tonal sound (e.g., crackling, humming) via a speaker. The battery design is a rolled and stacked battery, with two or more winding rolls of cathode and anode layers separated by insulation layers, the winding rolls also being separated by a distance with the distance, in some embodiments, filled with an insulating layer (e.g., a dielectric material). The two or more winding rolls are alternating in their stacking order. By way of example, consider a battery with two winding rolls. If the first winding roll has one anode and one cathode layer (separated by an insulative material) with the anode layer closest to the central axis at the innermost portion of the winding, the second winding roll will also have a single anode and cathode layer (separated by an insulative material), but the cathode will be closest to the central axis at the innermost portion of the winding. Embodiments with more than two winding rolls will alternate the order in a like manner from the adjacent winding roll or rolls.

This order alternation of the winding rolls may, in aspects, produce a much lower surface current than were there to be no alternating layers to the battery, such as in a battery with a single winding role made up of at least one anode layer and one cathode layer. The flow of electricity in the battery, including the surface current, may be mathematically represented by an electromotive force:

$$ϵ = \int \vec{E} \cdot d \vec{l} \qquad ( 1 )$$

Equation 1 shows an electromotive force c being equal to an electric field (E-field) integrated over a distance and direction. Faraday's Law further states:

$$ϵ = - \frac{d {Φ}_{B}}{dt} \qquad ( 2 )$$

Equation 2 equates c with a changing magnetic flux, Φ_{B}, which may be defined as:

$${Φ}_{B} = {\int }_{S} {μ}_{0} \vec{H} \cdot d \vec{A} \qquad ( 3 )$$

Equations 1, 2, and 3 demonstrate that a current, such as an induced surface current, may in turn motivate an H-field. Additionally, there may be a direct correlation between the strength and/or density of c and the associated H-field, as demonstrated by Equations 1, 2, and 3. Thus, a battery is provided for devices (e.g., small form factor devices) that reduces EMI (e.g., eNoise) typically created between a battery and a nearby electronic component (e.g., speaker, main logic board, circuit, etc.). By way of example, a speaker in an earbud can experience EMI via coupling its H-field with the H-field from the battery current, thus passing on unwanted noise artifacts to an end user. Reduction of the surface current on the battery therefore lowers the associated H-field, which in turn lowers effects from EMI. The disclosed battery configuration thereby increases the effectiveness, efficiency, and user satisfaction with devices and systems using the battery.

While features and concepts of the described techniques for a low-emission cylindrical-winding battery design can be implemented in any number of different environments, aspects are described in the context of the following examples.

### Example Batteries

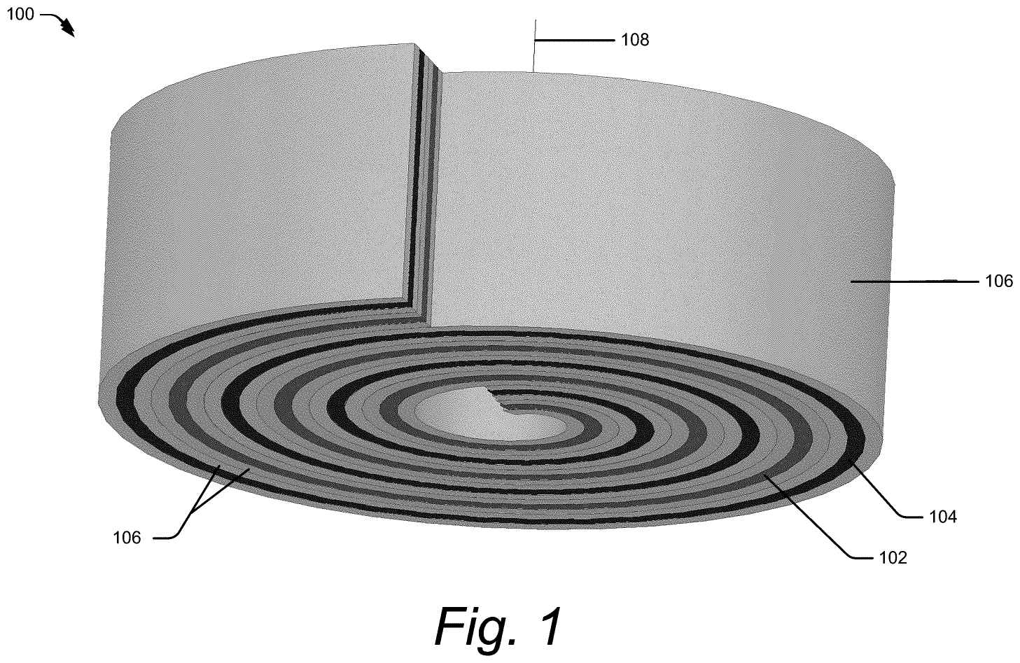

FIG. 1 illustrates an example implementation of a standard cylindrical-winding battery 100 configuration. The battery 100 includes an anode layer 102, a cathode layer 104, and an insulative layer or layers 106. The layers 102, 104, and 106 are wound around a central axis 108. The battery 100 may be a stacking cell battery, a coin cell battery, a button cell battery, or any other battery with a circular form factor. The layers 102, 104, and 106 are wound in a single direction around the central axis 108 such that they form alternating anode, cathode, and insulation areas.

The configuration of the alternating layers may, in aspects, produce a current along the surface of the battery 100, where the surface normal is in the direction of the indicated central axis line 108. As shown in Eqs. 1 through 3, this surface current will induce a corresponding H-field. The surface current for the battery 100 may, in some examples, have a marked unwanted effect on other electronic components if the battery 100 is used in a device where other electronic components are placed within range of the produced H-field. For example, a speaker in an earbud may have static or other unwanted eNoise due to the small form factor of an earbud placing the speaker in close proximity to the battery 100.

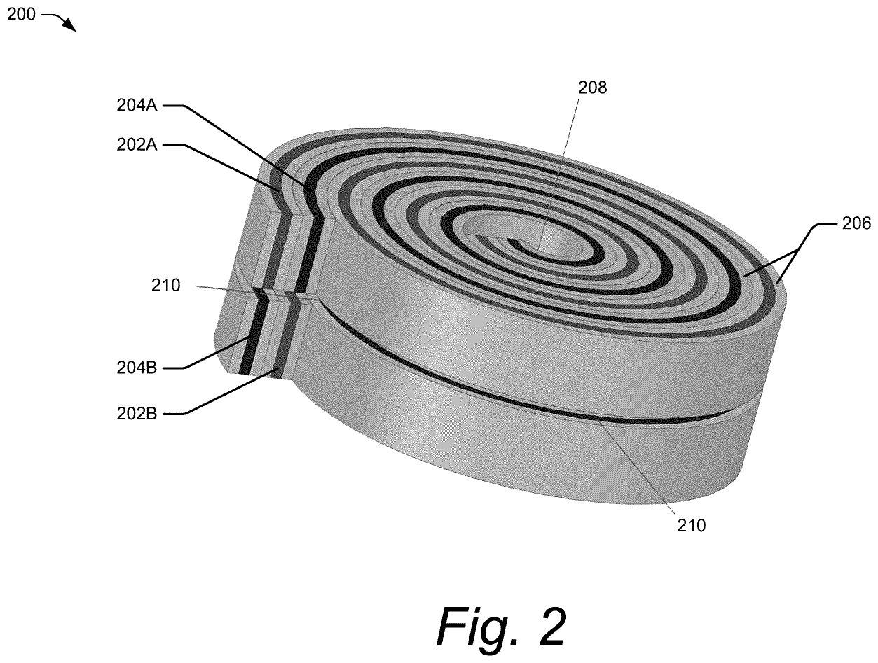

FIG. 2 illustrates an example implementation of a low-emission cylindrical-winding battery 200 configuration. Unlike the battery 100, the battery 200 has more than one winding roll of stacked layers. The battery 200 includes a first anode layer 202A, a first cathode layer 204A, a second anode layer 202B and a second cathode layer 204B. All anode and cathode layers 202A, 202B, 204A, and 204B are electrically separated by insulation layers 206.

The first anode layer 202A and the first cathode layer 204A are wound around a central axis 208. In the example battery 200 shown, the layers 202A and 204A, including the associated insulation layers 206, are would counter-clockwise around a central axis 208 with the cathode layer 204A closest to the central axis 208, forming a first winding roll. In the example battery 200 shown, the layers 202B and 204B, including the associated insulation layers 206, are would counter-clockwise around the central axis 208 with the anode layer 202B closest to the central axis 208, forming a second winding roll. In aspects, the first winding roll and the second winding roll are separated by a distance 210.

In aspects, the orientation of the stacked layers 202A and 204A is opposite to the order of the stacked layers 202B and 204B (i.e., that they are stacked in an opposite pattern). In some examples, this opposite stacking order has the effect of producing a first winding roll current in a first direction and a second winding roll current in a second direction. In some examples, as the layers 202A and 204A are in the opposite directions to one another, this alternating pattern has correspondingly alternate H-field directions. This serves, in aspects, to minimize the total produced H-field from all surface currents from the battery 200.

Although the example battery 200 of FIG. 2 shows two winding rolls (the first winding roll made up of the first anode layer 202A, first cathode layer 204A, and associated insulation layers 206 and the second winding roll made up of second anode layer 202B, second cathode layer 204B, and associated insulation layers 206), this should not be seen as limiting. Nor should the number of winds in the winding rolls be seen as limiting. Alternate embodiments with more than two winding rolls and/or with more or less winds for each of the winding rolls may, in aspects, be employed under the scope of the low-emission cylindrical-winding battery design disclosed herein.

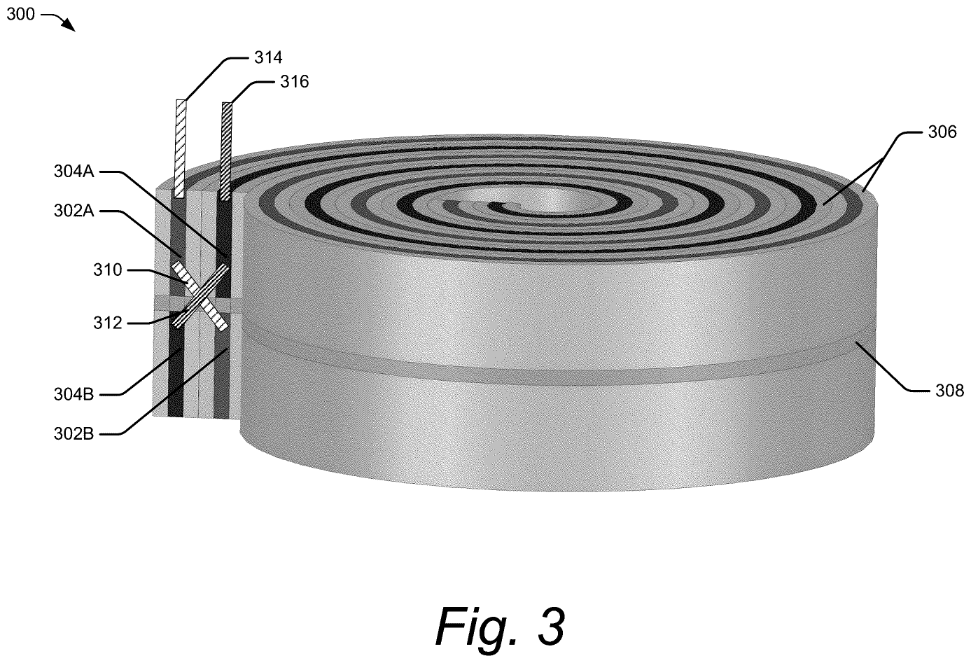

FIG. 3 illustrates a side plan view of the example battery 200 from FIG. 2. In aspects, the battery 300 includes a first anode layer 302A, a first cathode layer 304A, a second anode layer 302B, a second cathode layer 304B, and insulation layers 306. According to some examples, the first anode layer 302A, the first cathode layer 304A, and associated insulation layers 306 combine to form a first winding roll around a central axis. According to some examples, the second anode layer 302B, the second cathode layer 304B, and associated insulation layers 306 combine to form a second winding roll around the central axis. The first winding roll and the second winding roll, in aspects, are separated by a dielectric or otherwise insulative layer 308.

In aspects, the first anode layer 302A and the second anode layer 302B may be connected by an anode connection tab 310. According to some examples, the first cathode layer 304A and the second cathode layer 304B may be connected by a cathode connection tab 312. Further, in some examples, the first anode layer 302A and the second anode layer 302B may be in electrical connection with an anode battery tab 314. In some examples, the first cathode layer 304A and the second cathode layer 304B may be in electrical connection with a cathode battery tab 316.

Though the example battery 300 is shown with the anode battery tab 314 physically attached to the first anode layer 302A, this need not be the case. In aspects, the anode battery tab 314 may be instead connected to the second anode layer 302B, the anode connection tab 310, the anode battery tab 314 may be the anode connection tab 310, or any other configuration where the anode battery tab 314 is connected electronically to both the first anode layer 302A and the second anode layer 302B. Although the example battery 300 shows two anode layers 302A and 302B, there could be any number of anode layers above two; the two layers 302A and 302B are shown for ease of illustration, but this should not be seen as limiting.

Though the example battery 300 is shown with the cathode battery tab 316 physically attached to the first cathode layer 304A, this need not be the case. In aspects, the cathode battery tab 316 may be instead connected to the second cathode layer 304B, the cathode connection tab 312, the cathode battery tab 316 may be the cathode connection tab 312, or any other configuration where the cathode battery tab 316 is connected electronically to both the first cathode layer 304A and the second cathode layer 304B. Although the example battery 300 shows two cathode layers 304A and 304B, there could be any number of cathode layers above two; the two anode layers 304A and 304B are shown for ease of illustration, but this should not be seen as limiting.

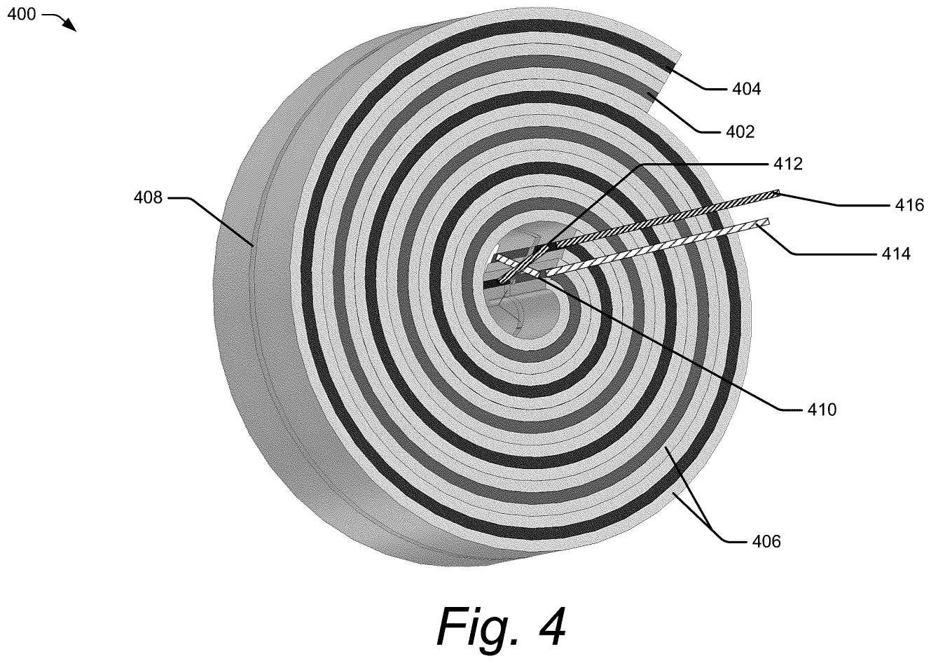

FIG. 4 illustrates an interior portion view of the example battery 200 from FIG. 2. A first winding roll in this example battery 400, shown in the foreground, includes an anode layer 402 and a cathode layer 404. There are also, in aspects, one or more insulation layers 406 between the anode layer 402 and the cathode layer 404. There is a second winding roll in the background, which is, in aspects, configured like the second roll of the batteries 200 and 300. The first winding roll and the second winding roll are, in aspects, separated by a dielectric layer 408.

In some examples, the first winding roll and the second winding roll have their anode and cathode layers electronically connected at their innermost points (instead of their outermost points, as in the anode connection tab 310 and the cathode connection tab 312). In the example battery 400, the anode layers (such as the anode layer 402) are, in aspects, connected by an anode connection tab 412, and the cathode layers (such as the cathode layer 404) are connected by a cathode connection tab 412.

In some examples, there may be a separate battery tab for each anode and cathode layer from the anode connection tab 410 and the cathode connection tab 412. In aspects, the example battery 400 includes an anode battery tab 414 and a cathode battery tab 416. The anode battery tab 414 is in electrical connection with the anode layers (such as the anode layer 402) and the cathode battery tab 416 is in electrical connection with the cathode layers (such as cathode layer 404).

Though the example battery 400 is shown with the anode battery tab 414 physically attached to the anode layer 402, this need not be the case. In aspects, the anode battery tab 414 may be instead connected to another anode layer, the anode connection tab 410, the anode battery tab 414 may be the anode connection tab 410, or any other configuration where the anode battery tab 414 is connected electronically to both the anode layer 402 and any other anode layers. Although the example battery 400 shows two anode layers (including the anode layer 402), there could be any number of anode layers above two.

Though the example battery 400 is shown with the cathode battery tab 416 physically attached to the cathode layer 404, this need not be the case. In aspects, the cathode battery tab 416 may be instead connected to another cathode layer, the cathode connection tab 412, the cathode battery tab 416 may be the cathode connection tab 412, or any other configuration where the cathode battery tab 416 is connected electronically to both the cathode layer 404 and any other cathode layers. Although the example battery 400 shows two cathode layers (including the cathode layer 404), there could be any number of cathode layers above two.

Any one of the example batteries 100, 200, 300, and 400 may be a Li-ion battery. Various Li-ion-battery chemistries may be implemented, some examples of which include lithium cobalt oxide (LiCoO2), lithium iron phosphate (LiFePO4), lithium manganese oxide (LiMn2O4 spinel, or Li2MnO3-based lithium-rich layered materials, LMR-NMC), and lithium nickel manganese cobalt oxide (LiNiMnCoO2, Li-NMC, LNMC, NMC, or NCM and the various ranges of Co stoichiometry). Also, Li-ion batteries may include various anode materials, including graphite-based anodes, silicon (Si), graphene, and other cation intercalation/insertion/alloying anode materials.

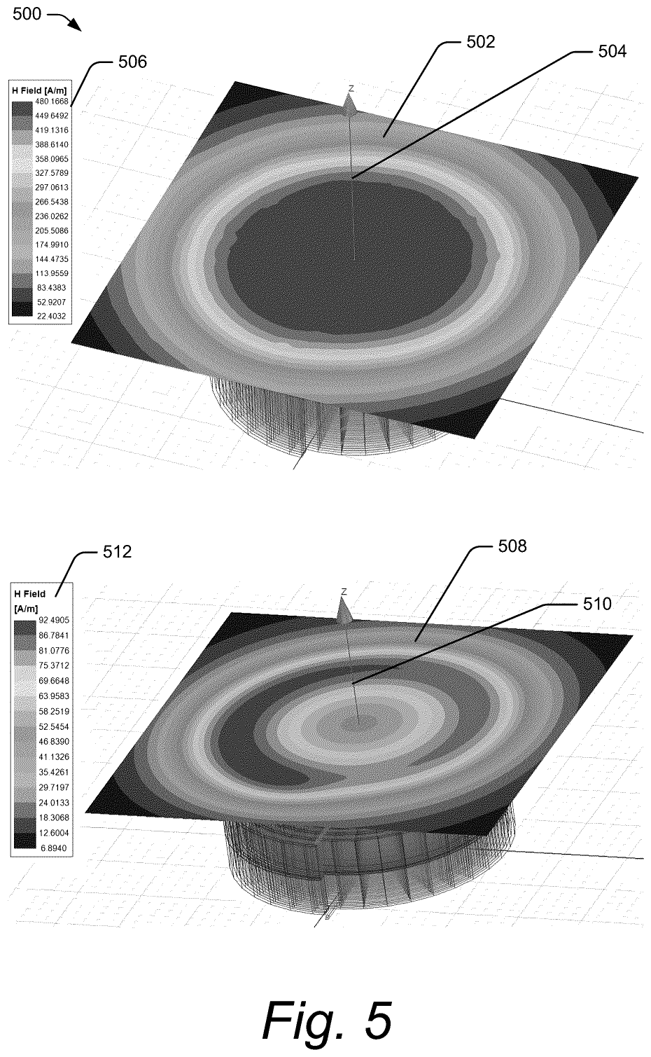

FIG. 5 illustrates a comparative H-field propagation between a standard cylindrical-winding battery configuration and a low-emission cylindrical-winding battery configuration. In aspects, H-field density plot 502 shows the relative H-field strength in the standard configuration. The H-field for the standard configuration, according to some examples, propagates in the z direction 504. In aspects, the standard H-field scale 506 shows the relative intensity for the density plot 502. Note that, according to some examples, the majority of the density plot 502 is at or above 480 A/m, indicating a relatively strong H-field propagation from surface currents.

In aspects, H-field density plot 508 shows the relative H-field strength in the low-emission configuration. The H-field for the low-emission configuration, according to some examples, propagates in the z direction 510. In aspects, the low-emission H-field scale 512 shows the relative intensity for the density plot 508. Note that, according to some examples, the density plot 508 has a high value of −92.5 A/m, indicating a relatively weak H-field propagation from surface currents. This example shows at least an 80% decrease in H-field strength between the standard configuration and the low-emission configuration. Note that, in this example, suppression of the H-field may be more than 80% as the standard H-field scale reaches its maximum at 480 A/m and the density plot 502 has a large relative area of saturation, indicating the possibility of an even higher peak value for the standard H-field.

It should be noted that, in some implementations, the example implementation of a standard cylindrical-winding battery 100 configuration of FIG. 1 can be configured to realize a low-emission cylindrical-winding battery configuration. Consider the anode layer 102 and the cathode layer 104. The anode layer 102, in aspects, has an overall length Lₐ, and the cathode layer 104, in aspects, has an overall length L_{c}. The relation of the lengths Lₐ and L_{c} may be expressed as:

$${L}_{a} = {L}_{c} + δ \qquad ( 4 )$$

Equation 4 expresses the difference between Lₐ and L_{c} by a difference parameter δ. In an ideal limit, δ=0 and Equation 4 becomes Lₐ=L_{c}. In such a configuration, an H-field generated by a current flowing through the anode layer 102 is equal to and opposite from an H-field generated by a current flowing through the cathode layer 104. In such an example, the overall H-field generated by the battery 100 is zero.

In real-world implementations, it may not be possible to manufacture the battery 100 such that δ=0 exactly. In some examples, there is an acceptability threshold K such that:

$$δ \leq κ \qquad ( 5 )$$

Equation 5 expresses the acceptable variability of S. The acceptability threshold K can be, in some examples, a manufacturing parameter determined by a maximum acceptable net H-filed for the battery 100. In aspects, configuring the battery 100 such that Equation 5 is satisfied can be expressed as Lₐ being substantially the same length as L_{c}. In some examples, the overall H-field of the battery 100 can be further minimized by placement of battery tabs (not pictured in FIG. 1) for the anode layer 102 and the cathode layer 104.

### CONCLUSION

Although aspects of a low-emission cylindrical-winding battery design have been described in language specific to features and/or methods, the subject of the appended claims is not necessarily limited to the specific features or methods described. Rather, the specific features and methods are disclosed as example implementations of techniques for a low-emission cylindrical-winding battery design, and other equivalent features and methods are intended to be within the scope of the appended claims. Further, various different aspects are described, and it is to be appreciated that each described aspect can be implemented independently or in connection with one or more other described aspects.

What is claimed is:

1. A battery having a symmetry about an axis and comprising:
a first plurality of layers, the first plurality of layers:
comprising first alternating cathode and anode layers, the first alternating cathode and anode layers electrically isolated from one another; and
disposed such that the first plurality of layers define a first cylindrical-winding roll about the axis; and
a second plurality of layers, the second plurality of layers:
comprising second alternating cathode and anode layers, the second alternating cathode and anode layers electrically isolated from one another; and
disposed such that:
the second plurality of layers define a second cylindrical-winding roll about the axis, the second cylindrical-winding roll adjacent to and electrically isolated from the first cylindrical-winding roll; and
the second alternating cathode and anode layers being arranged about the axis in an opposite order as the first alternating anode and cathode layers.

2. The battery of claim 1, further comprising:
an outer negative terminal for providing a current to both the first plurality of layers and the second plurality of layers, the outer negative terminal in electrical connection to the first anode layers and the second anode layers at their farthest point from the axis; and
an outer positive terminal for collecting the current within the first plurality of layers and the second plurality of layers, the outer positive terminal in electrical connection to the first cathode layers and the second cathode layers at their farthest point from the axis.

3. The battery of claim 1, further comprising:
an inner negative terminal for providing a current to both the first plurality of layers and the second plurality of layers, the inner negative terminal in electrical connection to the first anode layers and the second anode layers at their closest point from the axis; and
an inner positive terminal for collecting the current within the first plurality of layers and the second plurality of layers, the inner positive terminal in electrical connection to the first cathode layers and the second cathode layers at their closest point from the axis.

4. The battery of claim 1, wherein the electric isolation of the first plurality of layers from the second plurality of layers is achieved using a dielectric isolation layer therebetween.

5. The battery of claim 1, wherein the symmetry is a radial symmetry about the axis, the axis being a central axis.

6. The battery of claim 1, further comprising a third plurality of layers, the third plurality of layers:
comprising third alternating cathode and anode layers, the third alternating cathode and anode layers electrically isolated from one another; and
disposed such that:
the third plurality of layers define a third cylindrical-winding roll about the axis, the third cylindrical-winding roll adjacent to and electrically isolated from the second cylindrical-winding roll; and
the third alternating cathode and anode layers being arranged about the axis in a same order as the first alternating anode and cathode layers.

7. The battery of claim 6, wherein the electric isolation of the third plurality of layers from the second plurality of layers is achieved using a dielectric isolation layer therebetween.

8. The battery of claim 1, wherein the first cylindrical-winding roll and the second cylindrical-winding roll are separated by a distance.
